(19) United States
(12) Patent Application Publication
(10) Pub. No.: US 2013/0311391 A1
(43) Pub. Date: Nov. 21, 2013

(54) METHOD OF MARKETING CHARITABLE DONATIONS

(71) Applicant: Multiplier Effect, Inc., Osprey, FL (US)

(72) Inventor: Jim Tuggle, Sarasota, FL (US)

(21) Appl. No.: 13/794,896

(22) Filed: Mar. 12, 2013

Related U.S. Application Data
(60) Provisional application No. 61/647,206, filed on May 15, 2012.

(51) Int. Cl. G06Q 30/02

(52) U.S. Cl. CPC G06Q 30/0279
USPC 705/329

(57) ABSTRACT

A method of generating charitable donations without incurring marketing costs for the charity including the steps of making a donation to the charity and recording the donation amount in a computer database, paying a monthly fee to a redistribution pool and recording the monthly fee amount in a computer database, sponsoring a second member, calculating a redistribution amount based on a percentage from a lookup table from the redistribution pool based on the number of times the member appears in the database wherein a processor determines the redistribution amount, and paying the redistribution amount to the member. The charity may operate the invention directly under a license agreement, or contract with a marketing company that operates the invention, the fundraising efforts, generating donations to the charity and managing marketing. The method and system permit the charity to raise funds for charity while incurring no marketing expenses related to the fundraising.

### CROSS-REFERENCE TO RELATED APPLICATIONS

This application claims priority of U.S. Provisional Application 61/486,931 filed May 11, 2011 and U.S. Provisional Application 61/647,206 filed May 15, 2012, the contents of which are incorporated herein by reference.

### FIELD OF THE INVENTION

This invention relates generally to methods of marketing. More particularly, this invention relates to a method of marketing to generate charitable donations.

### BACKGROUND OF THE INVENTION

Charities raise funds for charitable work. There are many different types of fundraising for this purpose. However, most fundraising efforts require the charities to incur considerable expense in both finding donors and encouraging donations usually in the form of administrative and marketing costs. As a result, a relatively high percentage of the money raised is typically spent on the cost of fundraising. Every dollar spent on fundraising is diverted from the charitable work of the charitable organization.

### SUMMARY OF THE INVENTION

The present invention provides for a method and automated system for generating charitable donations. The method of generating charitable donations for a charity without incurring marketing costs for the charity includes the following steps: (1) making a donation to the charity online at a website dedicated to fundraising for the charity and recording the donation amount in the website's computer database (in a file), and (2) if the donor chooses to become a marketing member, paying a monthly fee and recording the monthly fee amount in a the website's computer database, and (3) if the marketing member sponsors one or more donors that become marketing members (referred to as donor/marketing members), the website calculates a redistribution amount. (4) The redistribution amount is based on a percentage of the monthly fee paid by marketing members and is set forth on the website's lookup table, representing the number of donor/marketing members that the member sponsors. (5) The website's processor determines the redistribution amount and (6) the website directs it's bank to pay the redistribution amount to the donor/marketing members each quarter. The activity on the computer or computer database including the use files for storage and recording of information. Files are created for each member or donor to be used for recording of fees, donations, or other activity. Payment may be made automatically by means of a computer based program or by ACH.

The charity may operate the invention directly under a license agreement, or it may contracts with a marketing company that operates the invention generating donations to the charity, and managing the marketing. The method and system permits the charity to raise funds for charitable work without incurring marketing expense.

The method is designed for charitable organizations to generate charitable donations without incurring any marketing expense. Through the online website dedicated to fundraising for the charity, the donation is transferred from the donor's bank to the charitable organization's bank via ACH (Automated Clearing House—a free money transfer service between banks). If the donor chooses to become a marketing member through the online website the donor authorizes its bank to transfer via ACH a monthly fee to a redistribution pool, the source of compensation for marketing members.

To drive the marketing effort, the redistribution pool, the source of compensation for marketing members is distributed via ACH transfers every 90 days back to the marketing members based on the marketing members' recruitment of new donor/marketing members in predetermined percentages found in lookup tables on the online website.

The method and automated system for generating charitable donations allows donors and donor/marketing members to raise funds for the charitable organization with no marketing costs to the charity.

The invention enables a user to make donations to a charitable organization without cost to the charitable organization and if the donor chooses to become a marketing member the donor can make a supplemental income based on it's payments and other members' payments to a redistribution pool.

### BRIEF DESCRIPTION OF THE DRAWINGS

FIG. 1 illustrates the method utilizing a web-based system administrator for redistributing funds to members;

FIG. 2 illustrates the method of redistributing predetermined percentages of funds back to members;

FIG. 3 illustrates the web-based system of the present invention;

FIG. 4 illustrates an example of the donation of the present invention;

FIG. 5 illustrates a lookup table of the present invention;

FIG. 6 illustrates a lookup table of the present invention;

FIG. 7 illustrates the predetermined redistribution pool percentage lookup table;

FIG. 8 illustrates a lookup table dictating the income of the users of the present invention;

FIG. 9 illustrates a lookup table dictating the number of people a user or member can sponsor;

FIG. 10 illustrates an output of the present invention;

FIG. 11 illustrates an output table of the present invention;

FIG. 12 illustrates a table of the present invention;

FIG. 13 illustrates the flow of funds as an example of the present embodiment; and

FIG. 14 illustrates the flow of funds for a marketing member an example of the present embodiment.

### DETAILED DESCRIPTION OF THE INVENTION

This invention is a method for generating donations to charitable organizations without cost to the charity. The charity may operate the invention directly under a license agreement, or it may contract with a marketing company that operates the invention in either case generating donations to the charity and managing the marketing. The method and system permits the charity to raise funds for charitable work while incurring no marketing expenses.

This method utilizes a web-based system administrator. A visitor to the website established for the fundraising effort can make a donation in any amount. In addition, a visitor to the site can choose to pay a specified monthly fee to enroll as a marketing member. The automated system also collects the monthly fee from the members. These monthly fees are redistributed among the members based on the members' success in obtaining donations to the charity and sponsoring other members. The receipt of the redistributed fees is an incentive for members to find other donors to the charity who also become members, As a result, the marketing is done by the members with no cost to the charity.

Using a template, visitors to the website can become donors and marketing members by enrolling online. In order to become a member, the member must make a fixed donation of a predetermined amount, in our illustration $99.00. The donation is made through the member's credit/debit card. The donation may also be made by various services, such as PayPal. The donation amount is paid directly to the charity. This portion incurs no marketing costs.

On the website each member authorizes the withdrawal from the marketing member's bank account a nominal monthly fee, in our illustration $3.00. The $3.00 fee is transferred each month via Automated Clearing House (ACH) from the marketing member's bank to the bank account established to receive and redistribute the fees (referred to as the marketing bank account). Each member can withdraw their membership and monthly fee without penalty at any time.

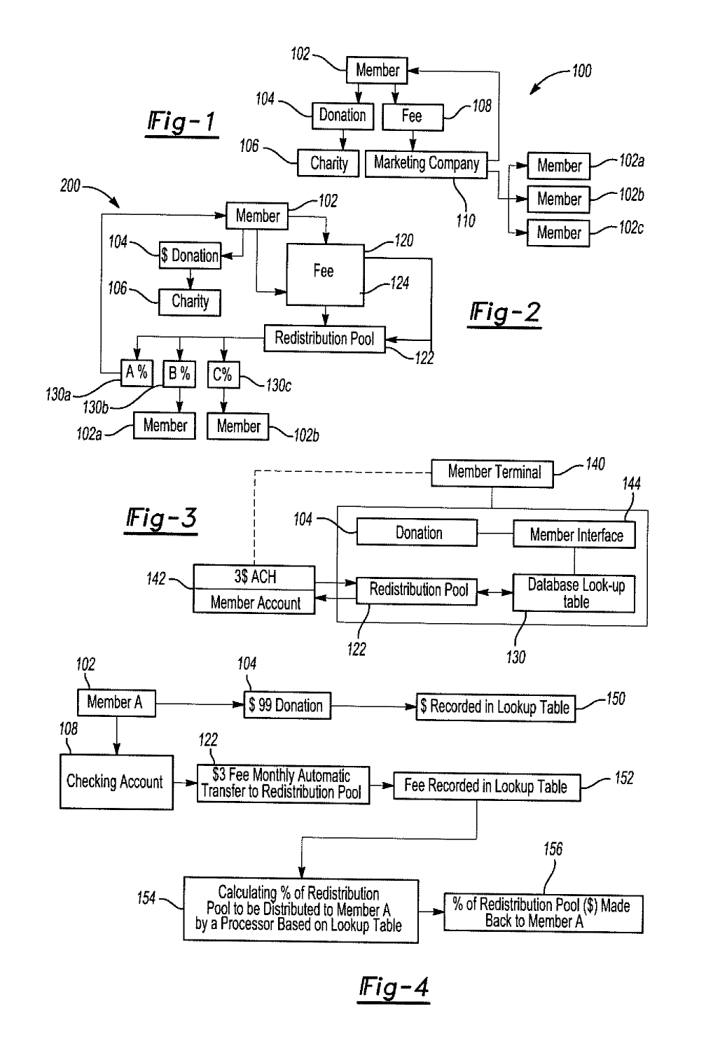

FIGS. 1 and 2 illustrate the flow of funds using the computer-based system of the present invention. In a typical example, a donor that makes a donation 104 directly to the charity 106. There is no further involvement of the donor in the illustration unless the donor chooses to also become a member (also referred to as a marketing member).

FIGS. 1 and 2 illustrate the member 102 making a donation 104 directly to the charity 106. In our example the donation 104 is $99.00. This donation 104 is made directly to the charity 106. The member 102 then makes a fee payment 108 on a monthly basis. The fee 108 is transferred from the member 102 bank account to the marketing bank account 110. The transfer of the fee 108 from the member 102 to the marketing company bank account 110 is made from bank to bank through an Automated Clearing House transfer system or program. The marketing company then redistributes the fee 108 via a redistribution pool to the members 102, 102a, 102b, 102c.

FIG. 2 illustrates a more detailed description of the method 100 as described in FIG. 1. FIG. 2 illustrates the method 200 having the member 102. The member 102 makes the $99.00 donation 104 to the charity 106. The member 102 also pays a monthly fee to the marketing company bank account 110.

The member 102 will pay the monthly fee by directly transferring the fee 124 from a checking account via ACH directly to the marketing company bank account 122. In our example, the monthly fee is $3.00 per month. After a predetermined time, in our example each quarter, the system administrator, specifically the computer-based system administrator, redistributes funds from the marketing company bank account 122 back to the members 102, 102a, 102b. The predetermined percentages A % 130a, B % 130b, and C % 130c all vary in accordance with the member 102, 102a, 102b and his success in sponsoring new donor/members. Specific percentages and predetermined percentages 130a, 130b, 130c will be discussed in the following paragraphs.

The member 102 may pay the monthly fee from any account having the ability to automatically transfer money to the marketing bank account as long as there is no cost to the member or the marketing company. Various investments or bank accounts may be utilized to serve this purpose.

The computer-based system administrator collects the $3.00 monthly fee from the members and places the monies into the marketing company bank account 122 which can also be referred to as the redistribution pool 122. The computer-based system administrator then calculates the predetermined percentages 130a, 130b, 130c in accordance with each member's sponsorship of new donors that become members and the success of those new members in sponsoring other new members. The redistribution of the collected fees motivates the members 102, 120a, 120b, 120c in sponsoring other members. The result is that more donations are made to the charity. FIG. 3 illustrates the marketing redistribution consisting of compensating members for sponsoring new donors that become members.

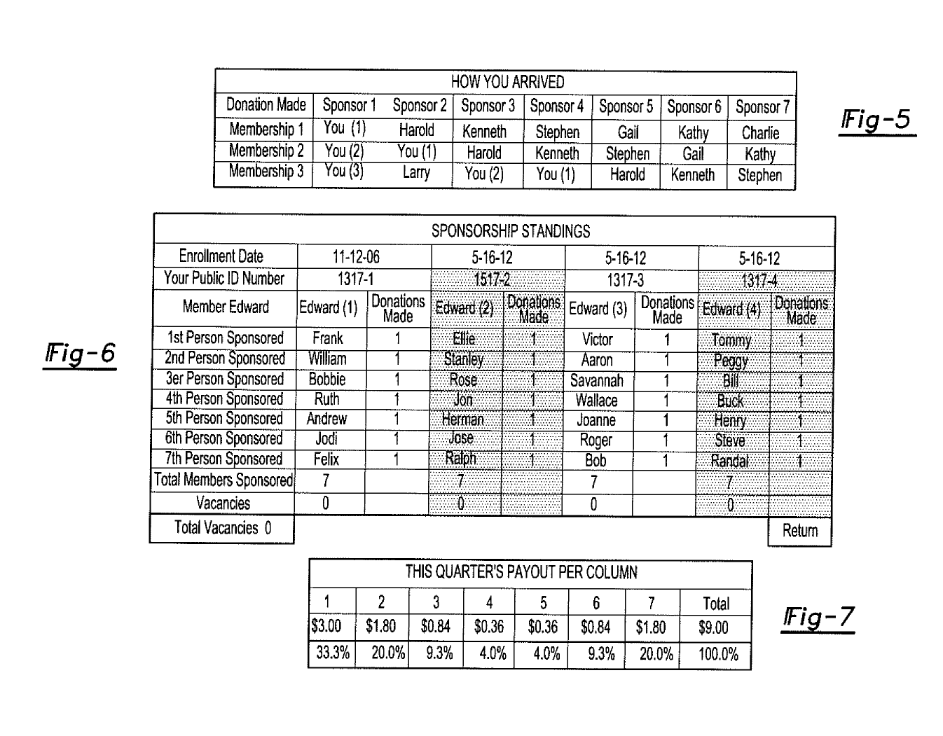

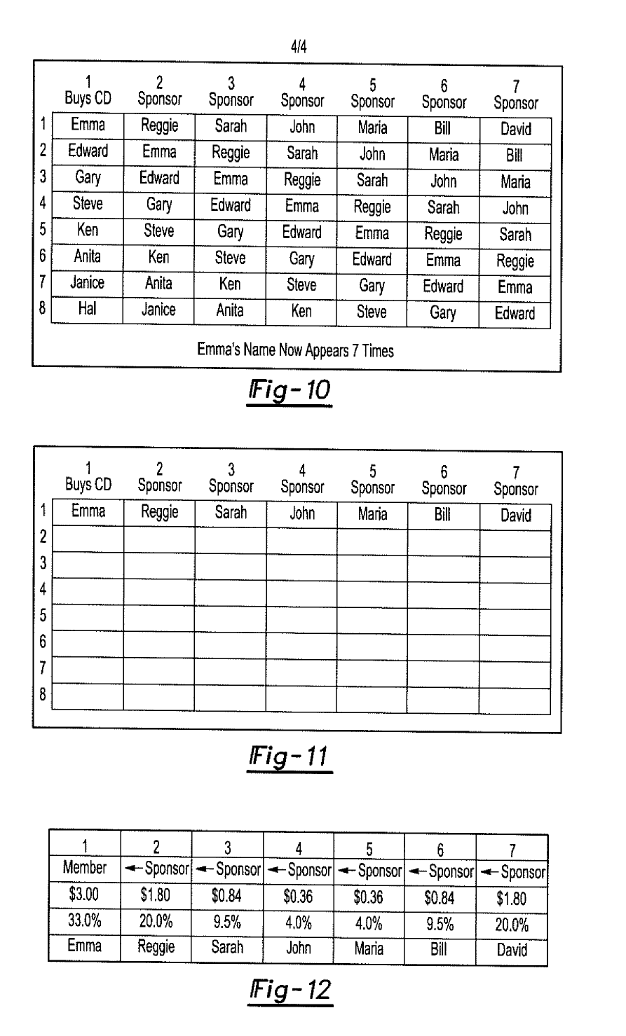

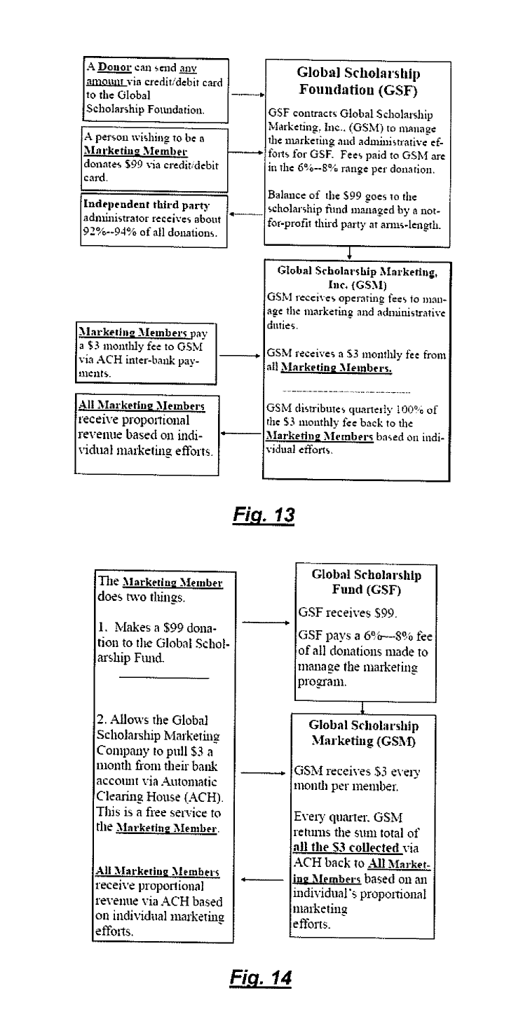

When a member enrolls, the system identifies the person that sponsored him or her and identifies the prior sponsor of that sponsor, and so on until it identifies the six prior sponsors. This chain of sponsorship is illustrated in FIGS. 5 and 6. This is a process of looking upstream in the link of sponsorship. The set of sponsors is like a branch of a family tree. FIG. 5 illustrates “you” as a new member. Harold sponsored you, Kenneth sponsored Harold, Stephen sponsored Kenneth, Gail sponsored Stephen, Kathy sponsored Gail, and Charlie sponsored Kathy. The last sponsor is Charlie. FIG. 5 illustrates you as a new member progressing through line 3 and will continue to progress when you fall out of the link after line 7. This falling out of the procession to 7 members is also illustrated in FIG. 10 row 8 where Emma has fallen out of the link. A member is limited to seven sponsorships per donation.

FIG. 3 illustrates the flow of funds between the member and the charity. A member terminal 140 is provided allowing the member 102 to make donations 104 to a charitable organization and payments of the monthly fee 108 to the redistribution pool 122. The member account 142 is provided allowing the transfer of funds to and from the redistribution pool 122. A database lookup table 130 is provided for storing information such as predetermined percentages, the number of times a sponsor appears, the amount of fees transferred from a member account to the marketing bank account, calculations of percentages for the redistribution pool, etc.

A member interface 144 is provided allowing a user accessing through the member terminal 140 to make donations. The donation 104 in the present example is a $99.00 donation. FIG. 10 illustrates that the marketing redistribution consists of compensating members for sponsoring new donors that become members. When a member enrolls, the system identifies the person that sponsored him or her and identifies the prior sponsor of that sponsor, and so on until it identifies six prior sponsors. This is the process of looking upstream in the link of sponsorship.

The set of sponsors is like a branch of a family tree. In the table, the new member is “Emma.” Reggie sponsored Emma, Sara sponsored John, and so on through the last prior sponsor in the set, David. The table as shown in FIG. 10 shows Emma as a new member on line 1 progressing through line 8 where Emma drops out of the link. She has sponsored one donor that became a member. Her name appears in seven branches. A member is limited to seven sponsorships per donation.

The table in FIG. 12 shows Emma and her six preceding sponsors, her upstream sponsors. A member that is upstream of a large number of referrals may receive a substantial amount of money from the redistribution pool.

The goal of the present invention is, in the present example, to provide scholarships to deserving Americans who need assistance for the cost of higher education in the United States. A supplemental goal is to reward members who participate in the fundraising for the charitable organization.

Anyone may donate any amount or refer an unlimited number of friends or relatives to make donations to the charity. A donation is made directly from the donor's bank account to the charity. To become a member, as well as a donor, a member application must be completed in full. The application to become a donor and a member requires both a $99 donation and a $3 per month commitment which allows the member to sponsor seven friends or relatives to participate in marketing of the scholarships.

Emma is the member as shown in FIGS. 10, 11, and 12. If Emma invites her friend Edward, FIG. 10, to visit the website and becomes a donor and a member, Emma will be rewarded for referring Edward. If Edward only makes a donation and does not become a member Emma is not rewarded. In FIGS. 10-12, because Emma referred Edward to the program and he became a donor/member, Reggie, Sara, John, Maria, and Bill will also be rewarded for the referral. If Edward refers a separate individual who becomes a donor/member, the line will continue to cycle through and Bill will be cycled through. FIG. 10 shows eight rows of the family tree starting with Emma until her name drops off in row 8. In column 2, we see that Emma has sponsored only one person, Edward. However, Emma's name still appears seven times. This is called the “multiplier effect.” If Emma continues to refer more friends to the marketing scholarship program, the greater her predetermined percentage of the redistribution pool will be. Emma is allowed to sponsor up to seven members and increase her predetermined percentage of the redistribution pool 122.

FIG. 7 illustrates the predetermined dollar amounts and percentages of every $9.00 collected per member per quarter. Columns 1-7 illustrate the dollar amounts and percentages attributable to each member in that quarter. By way of example, if Emma is in column I she is entitled to $3.00 or 33.33% of the total $9.00. If Reggie is in column 2 as a sponsor he is entitled to $1.80 or 20% of the $9.00 sum. These predetermined percentages may vary based on the system administrator. The predetermined dollar amounts and predetermined percentages as shown in FIG. 7 are totaled together each time a member's name appears in columns 1-7. Those funds are taken from the redistribution pool 122 and redistributed back to the members in accordance with the predetermined percentages 130a, 130b, 130c total based on the number of times the user's name appears in each of the columns 1-7.

In the present example as shown in FIGS. 10-12, Emma's name appears in column 1 one time. Her name can appear in column 2 a total of seven times. If those seven members sponsor seven more people who also become members Emma's name can appear in column 3 a total of 49 times. This concept is referred to as the multiplier effect. These numbers are used to determine the predetermined percentages 130a, 130b, 130c. Monies from the redistribution pool 122 are distributed four times per year, or quarterly, as long as the member remains a member.

A member may also sponsor herself. Emma has the capability of sponsoring herself thus giving Emma the capability of sponsoring seven more people.

Emma may also be sponsored by someone else. If a separate person sponsors Emma, Emma is given the opportunity to sponsor seven more people.

A member may make any number of $99.00 donations. For each $99.00 donation that is made, the member is given seven sponsorship opportunities. FIG. 8 illustrates the income recap of a full quarter. We look to the number of times a member's name appears in a column. Looking at the seven columns, we see how many times Emma's name appears in each column. The table as shown in FIG. 8 illustrates the total earnings for the member during the present quarter. In the present example, the member earned a total of $2,217.59.

FIG. 5 illustrates a separate example of the people that have sponsored you. The example as shown in FIG. 5 is what is shown to the user of the website. The people in columns 2-7 are the people who are responsible for sponsoring you as a member. FIG. 6 illustrates the people that you as an individual have sponsored.

The table entitled “Sponsorship Standings” illustrates the number of donations made. Emma (1) through Emma (4) indicates that Emma has donated four $99.00 memberships. Emma sponsored Edward for the first time on Nov. 12, 2008, by making one $99.00 donation. On May 16, 2012, he asked Emma to sponsor him again. This time he made three $99.00 donations (see columns 2, 3, and 4). If he had a vacancy he could have sponsored himself for those three times. With no vacancies available, he asked his friend Emma to sponsor him again.

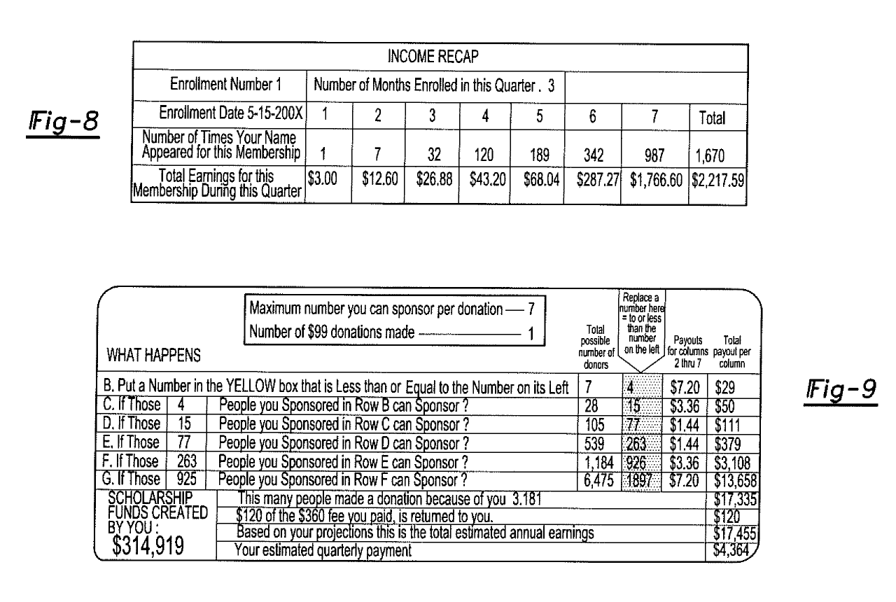

FIG. 9 illustrates an income estimator as shown by the member and user of the website. In the present example, your estimated quarterly payment is $4,364.00. The income estimator utilizes the number of people you have sponsored and the number of donations you have made. The income estimator and the income from the income estimator are pulled from the redistribution pod 122 as shown in FIGS. 1-4.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. A method of generating charitable donations to a charity without incurring marketing costs to the charity, the method comprising the steps of:
creating a file on a computer database for each member, recording a donation amount in the computer database;
paying a monthly fee to a redistribution pool and recording the monthly fee amount in a computer database, the monthly fee transferred by means of a computer based program;
sponsoring a second member by a member, a second file created for the second member;
applying a redistribution amount based on a percentage from a lookup table from the redistribution pool based on the number of times the member appears in the database, a processor determining the redistribution amount; and
paying the redistribution amount to each member based on percentages from the lookup table.

2. The method of generating charitable donations of claim 1 wherein the donation is deducted from a member's bank account.

3. The method of generating charitable funds of claim 1 wherein the monthly fee is deducted from a member's bank account at the same time every month.

4. The method of generating charitable donations of claim 2 wherein the donation is deducted from the member's bank account via an automated clearing house.

5. The method of generating charitable funds of claim 2 wherein the monthly fee is deducted from the member's bank account via an automated clearing house at the same time every month.

6. The method of generating charitable donations of claim 1 wherein a member interface is provided.

7. The method of generating charitable donations of claim 1 wherein the donation is is paid to the charitable organization.

8. The method of generating charitable funds of claim 2 wherein the monthly fee is deducted at the same time every month.

9. The method of generating charitable donations of claim 1 wherein an income estimator is provided allowing the user to estimate the amount of anticipated income that will be received from the redistribution pool in the form of a dollar figure.

10. The method of generating charitable donations of claim 1 wherein the redistribution pool is stored in a bank account.

11. The method of generating charitable donations of claim 1 wherein the processor is a computer.

12. The method of generating charitable donations of claim 1 wherein the system is accessed by the member by means of a website.
